(19) United States
(12) Patent Application Publication
(10) Pub. No.: US 2025/0174679 A1
(43) Pub. Date: May 29, 2025

(54) Bipolar plate for an electrochemical unit of an electrochemical device and electrochemical device

(71) Applicant: EKPO Fuel Cell Technologies GmbH, Dettingen (DE)

(72) Inventors: Michael SCHAICH, Dettingen (DE); Joachim SCHERER, Dettingen (DE)

(21) Appl. No.: 19/040,396

(22) Filed: Jan. 29, 2025

Related U.S. Application Data
(63) Continuation of application No. PCT/EP2023/069820, filed on Jul. 17, 2023.

(30) Foreign Application Priority Data
Aug. 1, 2022 (DE) 10 2022 119 221.0

(51) Int. Cl. H01M 8/026; H01M 8/0276

(52) U.S. Cl. CPC H01M 8/026; H01M 8/0276

(57) ABSTRACT

In order to create a bipolar plate for an electrochemical unit of an electrochemical device comprising a plurality of electrochemical units that follow one another along a stack direction, wherein the bipolar plate comprises the following:
an anode gas passage opening;
a cathode gas passage opening;
an electrochemically active region of the bipolar plate, which comprises an anode gas flow field and a cathode gas flow field;
an anode gas distribution region, by way of which the anode gas passage opening is in fluidic connection with the anode gas flow field; and
a cathode gas distribution region, by way of which the cathode gas passage opening is in fluidic connection with the cathode gas flow field;
wherein the anode gas distribution region and/or the cathode gas distribution region comprises distribution structures, which delimit distribution channels formed between two respective distribution structures, in which bipolar plate the anode gas is distributed an uniformly as possible to the distribution channels of the anode gas distribution region and/or the cathode gas is distributed as uniformly as possible to the distribution channels of the cathode gas distribution region, it is proposed that the anode gas distribution region and/or the cathode gas distribution region each has at least one bypass channel, by way of which two mutually adjacent distribution channels are in fluidic connection with one another.

### RELATED APPLICATIONS

This application is a continuation of international application number PCT/EP2023/069820 filed on 17 Jul. 2023 and claims the benefit of German application number 10 2022 119 221.0 filed on 1 Aug. 2022.

The present disclosure relates to the subject matter disclosed in international application number PCT/EP2023/069820 of 17 Jul. 2023 and German application number 10 2022 119 221.0 of 1 Aug. 2022, which are incorporated herein by reference in their entirety and for all purposes.

### FIELD OF THE DISCLOSURE

The present invention relates to a bipolar plate for an electrochemical unit of an electrochemical device comprising a plurality of electrochemical units that follow one another along a stack direction, wherein the bipolar plate comprises the following:
an anode gas passage opening, which forms a constituent part of an anode gas channel that extends along the stack direction through the electrochemical device;
a cathode gas passage opening, which forms a constituent part of a cathode gas channel that extends along the stack direction through the electrochemical device;
an electrochemically active region of the bipolar plate, which comprises an anode gas flow field that is able to be flowed through by the anode gas and a cathode gas flow field that is able to be flowed through by the cathode gas;
an anode gas distribution region, by way of which the anode gas passage opening is in fluidic connection with the anode gas flow field; and
a cathode gas distribution region, by way of which the cathode gas passage opening is in fluidic connection with the cathode gas flow field;
wherein the anode gas distribution region and/or the cathode gas distribution region comprises distribution structures extending along a flow direction of the anode gas and the cathode gas respectively, which delimit distribution channels formed between two respective distribution structures.

In known bipolar plates of this kind, the anode gas passage opening is surrounded by an anode gas sealing bead and the cathode gas passage opening is surrounded by a cathode gas sealing bead.

In order to pass the anode gas through the anode gas sealing bead, anode gas inlets are arranged on the inner side of the anode gas sealing bead facing toward the anode gas passage opening and anode gas outlets are provided on the outer side of the anode gas sealing bead facing away from the anode gas passage opening.

In order to enable a passage of the cathode gas through the cathode gas sealing bead, cathode gas inlets are provided on the inner side of the cathode gas sealing bead facing toward the cathode gas passage opening and cathode gas outlets are provided on the outer side of the cathode gas sealing bead facing away from the cathode gas passage opening.

The anode gas outlets can only be placed at certain points along the periphery of the anode gas sealing bead and the cathode gas outlets can only be arranged at certain points along the periphery of the cathode gas sealing bead. This is due to the technical condition that the anode gas sealing bead and the cathode gas sealing bead may not be weakened too greatly, and the condition of implementability in the forming tools by means of which the anode gas outlets and the cathode gas outlets are formed on the anode gas sealing bead and on the cathode gas sealing bead respectively by means of a reshaping operating, in particular by means of a stamping operation or a deep-drawing operation.

The distribution channels of the anode gas distribution region and the cathode gas distribution region are filled unevenly with the anode gas and the cathode gas because some distribution channels have an orifice opening facing toward the respective sealing bead, said opening lying in the extension of an anode gas outlet or of a cathode gas outlet, such that a high proportion of the anode gas or the cathode gas flows out of the respective outlet in the direction of the orifice opening of such a distribution channel.

Other distribution channels have orifice openings facing toward the respective sealing bead, said openings lying between the direct outflow paths of two anode gas outlets or two cathode gas outlets, such that only a small proportion of the anode gas or cathode gas flowing out of the respective outlets reaches the orifice openings of these distribution channels.

Because in the known bipolar plates the anode gas is guided through the distribution channels of the anode gas distribution region up to the anode gas flow field without leaving the distribution channel originally filled with flow, and the cathode gas travels through the distribution channels of the cathode gas distribution region to the cathode gas flow field without leaving the respective distribution channel originally filled with flow, the uneven distribution of the anode gas and of the cathode gas to the orifice openings of the distribution channels of the respective distribution region also leads to an unequal distribution of the anode gas over the anode gas flow channels of the anode gas flow field and to an unequal distribution of the cathode gas over the cathode gas flow channels of the cathode gas flow field.

As a result of such an unequal distribution of the anode gas and/or of the cathode gas over the respective flow fields of the electrochemically active region of the bipolar plate, the performance and the efficiency of the electrochemical device in which such bipolar plates are used are reduced.

In accordance with an embodiment of the invention, a bipolar plate for an electrochemical unit of an electrochemical device of the kind stated at the outset is created, in which the anode gas flowing out of the anode gas passage opening is distributed as uniformly as possible to the distribution channels formed between the distribution structures of the anode gas distribution region and/or the cathode gas flowing out of the cathode gas passage opening is distributed as uniformly as possible to the distribution channels formed between the distribution structures of the cathode gas distribution region.

### SUMMARY OF THE INVENTION

In accordance with an embodiment of the invention, a bipolar plate having the features of the preamble of claim 1 is provided, in which the anode gas distribution region and/or the cathode gas distribution region each has at least one respective bypass channel, by way of which two adjacent distribution channels are in fluidic connection with one another.

Due to the bypass channels in the anode gas distribution region, anode gas is able to flow from a distribution channel into which a disproportionate amount of anode gas is flowing out of the anode gas outlets into an adjacent distribution channel that contains less anode gas from the anode gas outlets.

Likewise, due to the bypass channels in the cathode gas distribution region, cathode gas is able to flow from a distribution channel that contains a disproportionate amount of cathode gas from the cathode gas outlets into an adjacent distribution channel that contains less cathode gas from the cathode gas outlets.

In this way, the filling of the distribution channels with anode gas and cathode gas is made more uniform.

As a result of this, the anode gas flow channels of the anode gas flow field that are supplied with anode gas from the anode gas distribution region and the cathode gas flow channels of the cathode gas flow field that are supplied with cathode gas from the cathode gas distribution region are filled more uniformly with anode gas and with cathode gas respectively.

The distribution structures between which the distribution channels are formed may be configured, e.g., as distribution webs, which extend substantially linearly along a longitudinal direction of the respective distribution structure.

In a preferred embodiment of the invention, provision is made that the at least one bypass channel is formed by a local depression of one of the distribution structures.

The local depression corresponds preferably to at least 5%, in particular at least 10%, particularly preferably at least 20%, of the height of the locally depressed distribution structure in a non-depressed portion of the distribution structure.

Here, the height of the distribution structure is preferably measured starting from a longitudinal central plane of the bipolar plate oriented perpendicularly to the stack direction, along which plane an anode-side bipolar plate layer and a cathode-side bipolar plate layer of the bipolar plate abut against one another.

Further, it is favorable if the local depression of the distribution structure by which a bypass channel is formed corresponds to at most 95%, in particular at most 90%, particularly preferably at most 80%, for example at most 50%, of the height of the locally depressed distribution structure in a non-depressed portion of the distribution structure.

The local depression is preferably at least 20 μm, in particular at least 40 μm, particularly preferably at least 80 μm.

Furthermore, the local depression is preferably at most 380 μm, in particular at most 360 μm, particularly preferably at most 320 μm, for example at most 200 μm.

The extent of the local depression of the distribution structure in the longitudinal direction of the locally depressed distribution structure is preferably at most 1.5 mm. This prevents a component of an electrochemical unit supported by the respective distribution structure, for example a gas diffusion layer or a part of a seal arrangement of an electrochemical unit, from not being sufficiently supported by the respective distribution structure and thereby bulging into the respective bypass channel, which would undesirably reduce the cross-section of the respective bypass channel that is able to be flowed through.

In a preferred embodiment of the invention, provision is made that the anode gas passage opening is surrounded by an anode gas sealing bead, on the outer side of which facing away from the anode gas passage opening an anode gas outlet is arranged, and the cathode gas passage opening is surrounded by a cathode gas sealing bead, on the outer side of which facing away from the cathode gas passage opening a cathode gas outlet is arranged.

During the operation of the electrochemical device, the largest proportion of the anode gas flowing out of the anode gas outlet flows into a distribution channels that is referred to in the following as a first-order distribution channel of the anode gas distribution region.

Furthermore, the largest proportion of the cathode gas flowing out of the cathode gas outlet flows into a distribution channel that is referred to in the following as a first-order distribution channel of the cathode gas distribution region.

Adjacent to the respective first-order distribution channel are two second-order distribution channels, and adjacent to each of the second-order distribution channels (except for the respectively associated first-order distribution channel) is a respective third-order distribution channel or a further second-order distribution channel.

During the operation of the electrochemical device, more anode gas or more cathode gas flows into a first-order distribution channel than into a second-order distribution channel, and more anode gas or cathode gas flows into a second-order distribution channel than into a first-order distribution channel.

In order to compensate for the uneven filling of the first-order to third-order distribution channels, provision is preferably made that the respective first-order distribution channel is in fluidic connection with the two adjacent second-order distribution channels by way of a respective first-order bypass channel.

Provision is preferably further made that the second-order distribution channels are each in fluidic connection with the respective adjacent third-order distribution channel or optionally with the respective adjacent further second-order distribution channel by way of a second-order bypass channel.

Here, it is particularly favorable for a uniform distribution of the anode gas and the cathode gas to the first-order to third-order distribution channels if the first-order bypass channels each have a larger cross-section that is able to be flowed through than the second-order bypass channels.

The cross-section of a bypass channel that is able to be flowed through is hereby taken perpendicularly to the longitudinal direction of extent of the respective bypass channel and thus substantially in parallel to the longitudinal directions of the distribution channels connected to one another by the bypass channel and in parallel to the stack direction.

Furthermore, it is favorable for a uniform distribution of the anode gas and the cathode gas to the first-order to third-order distribution channels if the second-order bypass channels overlap at least partially with the respective adjacent first-order bypass channels, when viewed in a direction oriented perpendicularly to the longitudinal direction of the first-order distribution channel and perpendicularly to the stack direction. It is thus possible that anode gas or cathode gas flowing out of a first-order bypass channel flows into the adjacent second-order bypass channel without changing its flow direction.

Independently of how large the cross-sections of adjacent bypass channels that are able to be flowed through are, it is favorable for a distribution that is as uniform as possible of the anode gas and the cathode gas to the distribution channels of the anode gas distribution region and the cathode gas distribution region respectively if at least one bypass channel overlaps at least partially with at least one bypass channel formed in an adjacent distribution structure, when viewed in a direction oriented perpendicularly to the longitudinal direction of the distribution structure on which the respective bypass channel is formed and perpendicularly to the stack direction.

In a preferred embodiment of the invention, provision is made that more than half of the directed distribution structures of the anode gas distribution region and/or more than half of the directed distribution structures of the cathode gas distribution region are each provided with at least one respective bypass channel.

It is particularly favorable for a uniform distribution of the anode gas and the cathode gas if all directed distribution structures of the anode gas distribution region and/or all directed distribution structures of the cathode gas distribution region are each provided with at least one respective bypass channel.

A further homogenization of the filling of the anode gas flow field with anode gas and of the cathode gas flow field with cathode gas can be achieved if at least one distribution structure of the anode gas distribution region and/or at least one distribution structure of the cathode gas distribution region is provided with two or more bypass channels spaced at a distance from one another in the longitudinal direction of the respective distribution structure.

A bypass channel formed on a distribution structure is preferably located closer to an end of the respective distribution structure that points toward the anode gas passage opening or the cathode gas passage opening than to an end of the respective distribution structure that points toward the electrochemically active region of the bipolar plate.

It is further advantageous if at least one distribution structure of the anode gas distribution region and/or at least one distribution structure of the cathode gas distribution region is provided with a bypass channel, the distance of which from an end of the respective distribution structure pointing away from the electrochemically active region of the bipolar plate along the longitudinal direction of the distribution structure is greater than the extent of the bypass channel along the longitudinal direction of the distribution structure.

The bipolar plate in accordance with the invention in suited, in particular, for use in an electrochemical device comprising a plurality of electrochemical units that follow one another along a stack direction and each comprise a respective bipolar plate in accordance with the invention.

Such an electrochemical device may be configured, for example, as a fuel cell device or as an electrolyzer.

For example, such an electrochemical device may be configured as a polymer electrolyte membrane (PEM) fuel cell device.

Further features and advantages of the invention are the subject matter of the subsequent description and the illustrative depiction of an exemplary embodiment.

### BRIEF DESCRIPTION OF THE DRAWINGS

FIG. 1 shows a plan view of a bipolar plate for an electrochemical unit of an electrochemical device comprising a plurality of electrochemical units that following one another along a stack direction, wherein the bipolar plate comprises an anode gas passage opening, which forms a constituent part of an anode gas channel that extends along the stack direction through the electrochemical device, a cathode gas passage opening, which forms a constituent part of a cathode gas channel that extends along the stack direction through the electrochemical device, an electrochemically active region of the bipolar plate, which comprises an anode gas flow field that is able to be flowed through by the anode gas and a cathode gas flow field that is able to be flowed through by the cathode gas, an anode gas distribution region, by way of which the anode gas passage opening is in fluidic connection with the anode gas flow field, and a cathode gas distribution region, by way of which the cathode gas passage opening is in fluidic connection with the cathode gas flow field, wherein the anode gas distribution region and the cathode gas distribution region comprise directed distribution structures extending along a flow direction of the anode gas and the cathode gas respectively, which delimit distribution channels formed between two respective distribution structures, and wherein the anode gas distribution region and the cathode gas distribution region each have a plurality of bypass channels, by way of which two respective adjacent distribution channels are in fluidic connection with one another, with the viewing direction toward the anode side of the bipolar plate;

FIG. 2 shows an enlarged depiction of the left end region the bipolar plate from FIG. 1;

FIG. 3 shows an enlarged depiction of the region I from FIG. 2;

FIG. 4 shows a perspective depiction of the region of the bipolar plate depicted in FIG. 3, with the viewing direction toward the anode side of the bipolar plate;

FIG. 5 shows a partial longitudinal section through the bipolar plate from FIGS. 1 to 4, in parallel to a distribution structure of the anode gas distribution region, along line 5-5 in FIG. 3;

FIG. 6 shows a partial longitudinal section through the bipolar plate from FIGS. 1 to 4, transverse to distribution structures of the anode gas distribution region, along line 6-6 in FIG. 3;

FIG. 7 shows a partial longitudinal section through the bipolar plate from FIGS. 1 to 4, transverse to distribution structures of the anode gas distribution region, in the region of bypass channels of the anode gas distribution region, along line 7-7 in FIG. 3;

FIG. 8 shows a plan view of the bipolar plate from FIG. 1 along the stack direction, with the viewing direction toward the cathode side of the bipolar plate;

FIG. 9 shows an enlarged depiction of the left end region of the bipolar plate from FIG. 8;

FIG. 10 shows an enlarged depiction of region II from FIG. 9;

FIG. 11 shows a perspective depiction of the region of the bipolar plate depicted in FIG. 10, with the viewing direction toward the cathode side of the bipolar plate;

FIG. 12 shows a partial longitudinal section through the bipolar plate from FIGS. 1 to 11, in parallel to a distribution structure of the cathode gas distribution region, along line 12-12 in FIG. 10;

FIG. 13 shows a partial longitudinal section through the bipolar plate from FIGS. 1 to 11, transverse to distribution structures of the cathode gas distribution region, along line 13-13 in FIG. 10; and

FIG. 14 shows partial longitudinal section through the bipolar plate from FIGS. 1 to 11, transverse to distribution structures of the cathode gas distribution region, in the region of bypass channels of the cathode gas distribution region, along line 14-14 in FIG. 10.

### DETAILED DESCRIPTION OF THE INVENTION

The same or functionally equivalent elements are provided with the same reference numerals in all Figures.

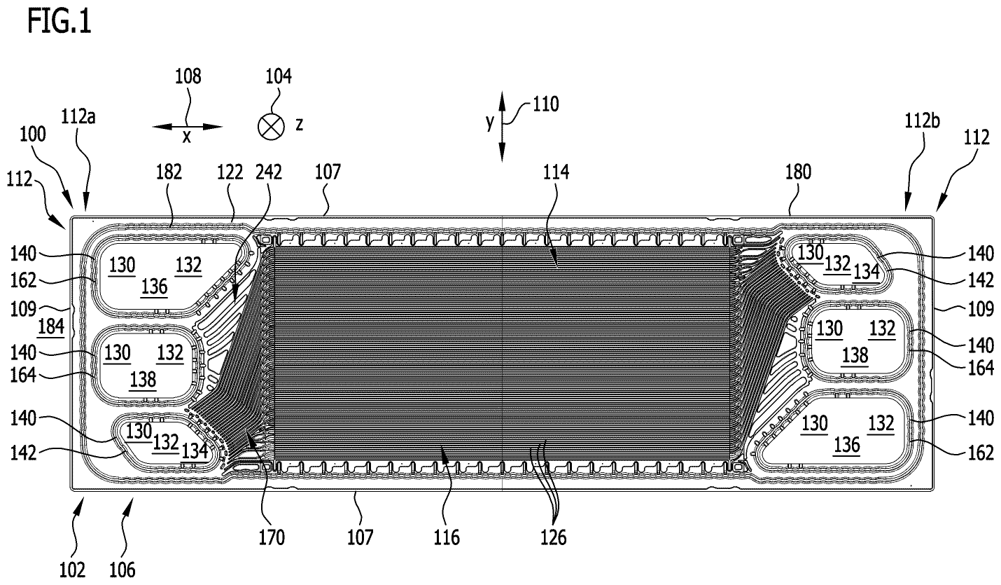

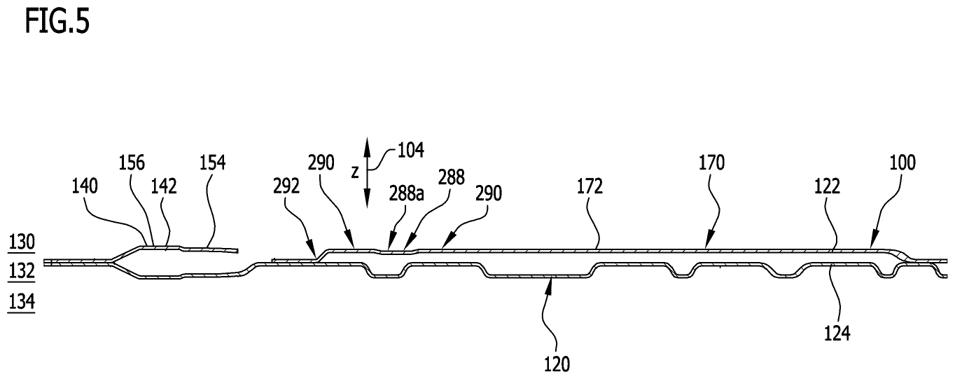

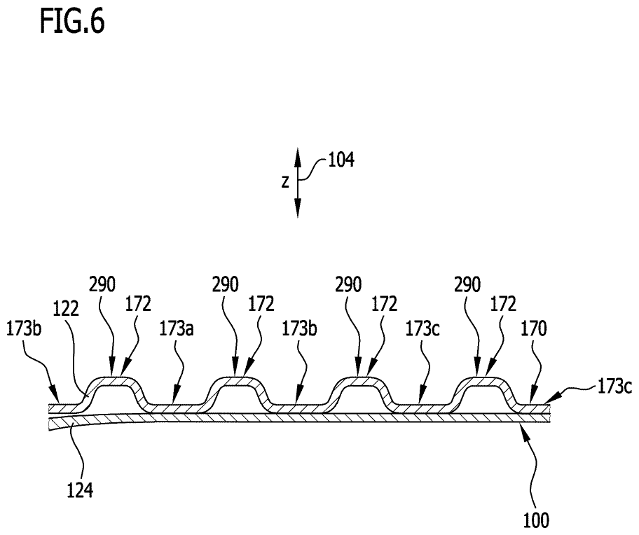

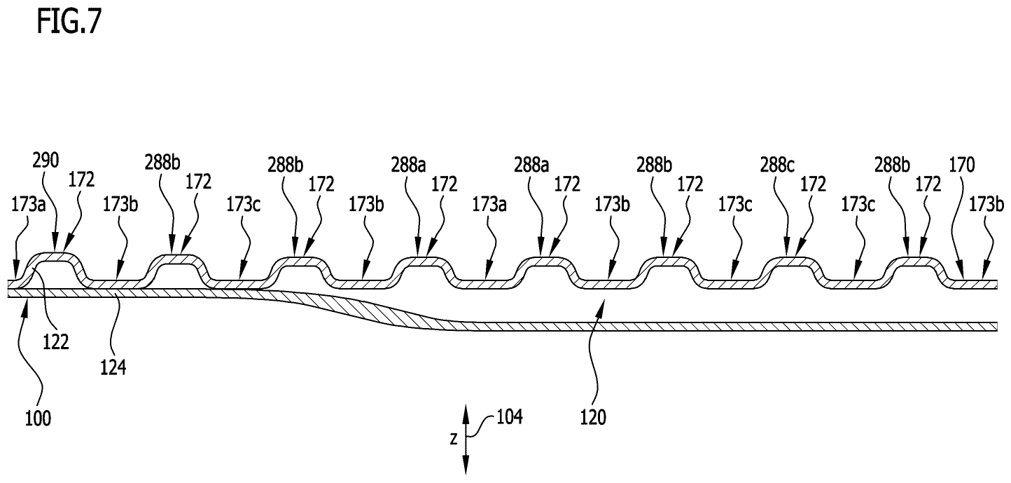

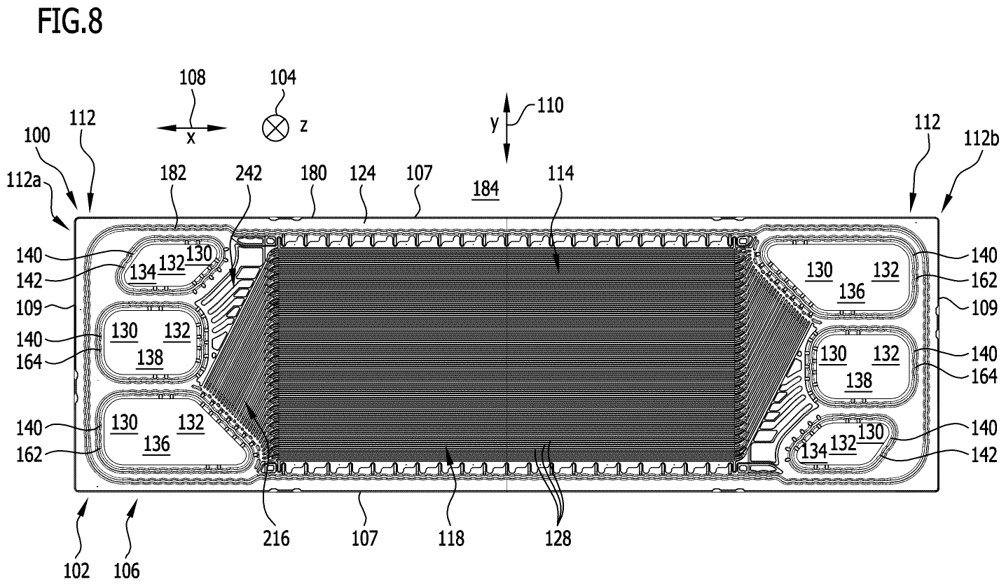

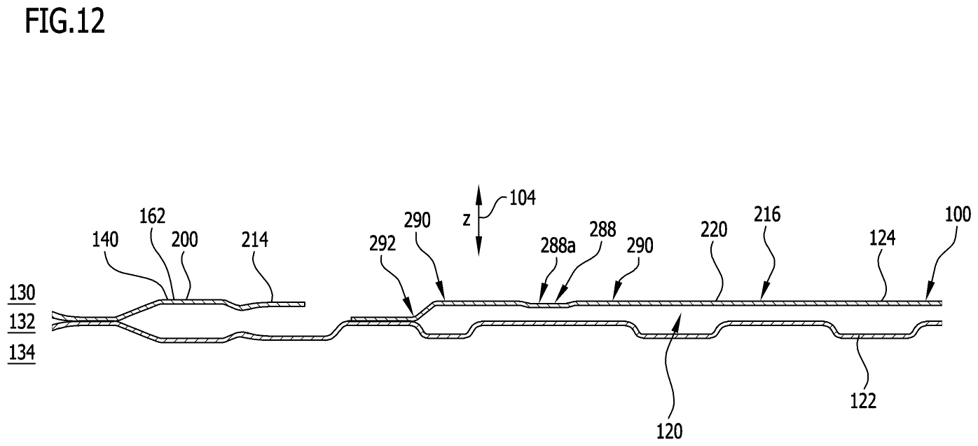

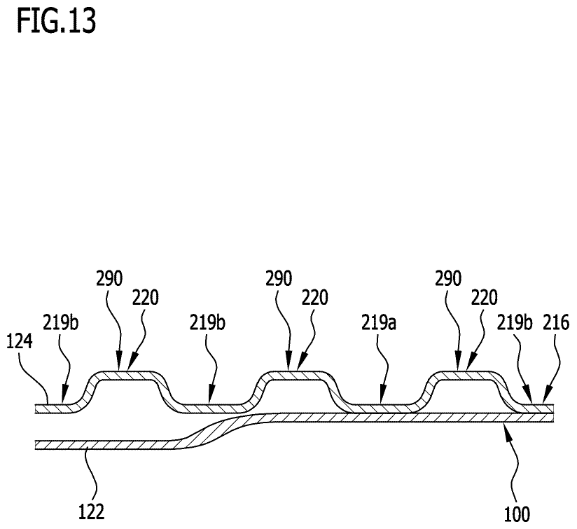

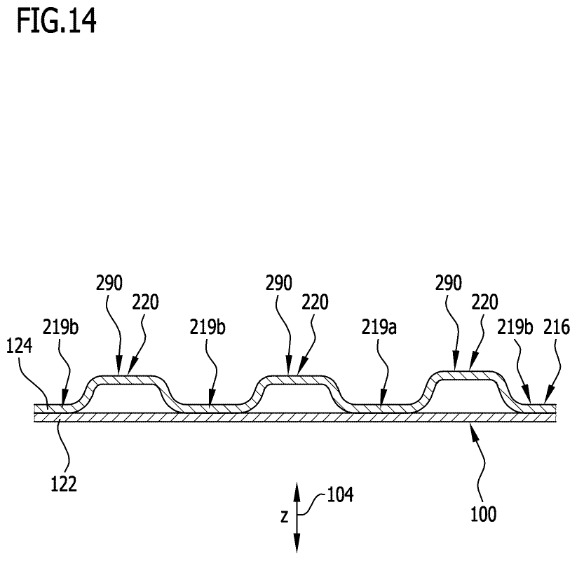

A bipolar plate, depicted in FIGS. 1 to 14 and denoted as a whole with 100, forms a constituent part of an electrochemical unit 102 (not depicted as a whole) which, in addition to the bipolar plate 100, may comprise a membrane-electrode arrangement, gas diffusion layers, and a seal arrangement.

A plurality of such electrochemical units 102 follow one another along a stack direction 104 to form a stack of electrochemical units 102, which is a constituent part of an electrochemical device 106, for example a fuel cell device.

The bipolar plate 100 has a substantially rectangular shape, wherein long sides 107 of the bipolar plate 100 extend along a longitudinal direction 108 and short sides 109 of the bipolar plate 100 extend along a transverse direction 110 of the bipolar plate 100.

The longitudinal direction 108 and the transverse direction 110 are preferably oriented perpendicularly to one another and perpendicularly to the stack direction 104.

The longitudinal direction 108 is also referred to as the x-direction, the transverse direction 110 is referred to as the y-direction, and the stack direction 104 is referred to as the z-direction.

The x-direction, the y-direction, and the z-direction span a right-angled coordinate system.

The bipolar plate 100 has two end regions 112 and an electrochemically active region 114 located between the end regions 112.

The electrochemically active region 114 of the bipolar plate 100 comprises an anode gas flow field 116 that is able to be flowed through by an anode gas, a cathode gas flow field 118 that is able to be flowed through by a cathode gas, and a coolant flow field 120 that is able to be flowed through by a coolant.

In the case of the embodiment described here, the bipolar plate 100 is of two-layer configuration and comprises an anode-side bipolar plate layer 122 on which the anode gas flow field 116 is formed and a cathode-side bipolar plate layer 124 on which the cathode gas flow field 118 is formed.

The bipolar plate layers 122 and 124 consist of a material that has good electrical conductivity, preferably a metallic material.

The bipolar plate layers 122 and 124 are connected to another by a material joint, preferably welded, along joint lines (not depicted), in particular by laser welding.

The anode flow field 116 of the bipolar plate 100 is in fluidic connection with an anode-side electrode of a membrane-electrode arrangement, optionally by way of an anode-side gas diffusion layer.

The cathode flow field 118 of the bipolar plate 100 is in fluidic connection with a cathode-side electrode of a membrane-electrode arrangement, optionally by way of a cathode-side gas diffusion layer.

Anode gas and cathode gas can thus travel from the electrochemically active region 114 of the bipolar plate 100 to the electrochemically active regions of a respective membrane-electrode arrangement. Therefore, the region of the bipolar plate 100 provided with the anode gas flow field 116 and the cathode gas flow field 118 is referred to as its electrochemically active region 114, although no electrochemical reactions take place on the bipolar plate 100 itself.

The anode gas flow field 116 comprises anode gas flow channels 126, the main flow direction of which is oriented in parallel with the longitudinal direction 108 (x-direction) of the bipolar plate 100.

The cathode gas flow field 118 comprises cathode gas flow channels 128, the main flow direction of which extends in parallel with the longitudinal direction 108 (x-direction) of the bipolar plate 100.

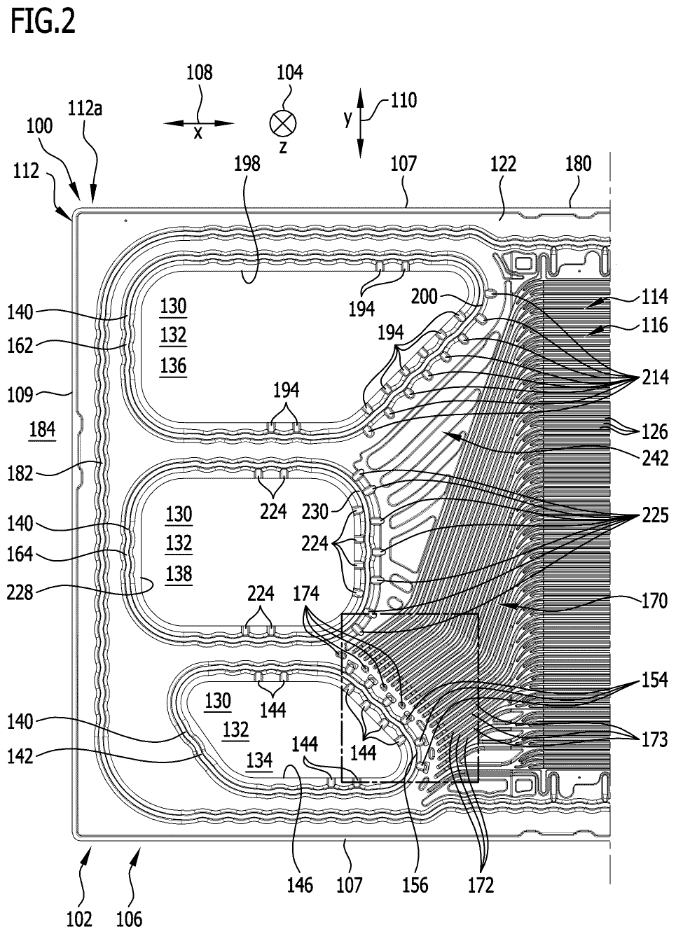

In its end regions 112, of which a first end region 112a is depicted in FIGS. 2 to 7 and 9 to 14, the bipolar plate 100 has in each case a plurality of medium passage openings 130 through which a respective fluid medium to be supplied to the electrochemical device 106 (an anode gas (combustion gas, for example hydrogen), a cathode gas (oxidizer, for example oxygen or air), or a coolant (for example water)) is able to pass through the bipolar plate 100. The medium passage openings 130 of the bipolar plates 100 following one another in the stack of electrochemical units 102 and the interspaces located between the medium passage openings 130 in the stack direction 104 together form a respective medium channel 132.

Associated with each of the medium channels 132 in one of the end regions 112 of the bipolar plate 100, through which a fluid medium is suppliable to the electrochemical device 100, is a respective other medium channel 132 in the respective opposite end region 112, through which the respective fluid medium is dischargeable from the electrochemical device 106.

The fluid media hereby travel through the anode gas flow field 116, the cathode gas flow field 118, and the coolant flow field 120 in the electrochemically active region 114 of the bipolar plate 100 from the one end region 112 to the other end region 112.

Arranged in the first end region 112a of the bipolar plate 100 depicted in FIGS. 2 to 7 and 9 to 14 are an anode gas passage opening 134, a cathode gas passage opening 136, and a coolant passage opening 138.

In principle, each of these passage openings 134, 136, and 138 may hereby selectively serve to supply the respective medium to the electrochemical device 106 or to discharge the respective medium from the electrochemical device 106.

In principle, each of the three media (anode gas, cathode gas, and coolant) can flow through the electrochemically active region 114 in parallel to the respective other media or with an opposite main flow direction relative to the main flow directions of one or two of the other media.

In a preferred embodiment of the invention, provision is made that all passage openings 134, 136, and 138 arranged in the first end region 112a of the bipolar plate 100 serve to supply the respective medium to the electrochemical device 106 and the passage openings 134, 136, and 138 arranged in the second end region 112b of the bipolar plate 100 serve to discharge the respective medium from the electrochemical device 106.

In order to prevent undesired leakage of the fluid media out of the respectively associated passage openings 134, 136, and 138, each of these passage openings is provided with a respective sealing bead 140.

The anode gas passage opening 134 is surrounded by an anode gas sealing bead 142.

In order to be able to supply the anode gas from the anode gas passage opening 134 to the anode gas flow field 136, the anode gas sealing bead 142 is provided with a plurality of anode gas inlets 144 on its inner side facing toward the anode gas passage opening 134, through which anode gas inlets anode gas is able to flow from the anode gas passage opening 134 into the interior space of the anode gas sealing bead 142 (see FIG. 2).

The anode gas inlets 144 each open on a rim 146 of the anode gas passage opening 134.

In the graphically depicted embodiment, the rim 146 of the anode gas passage opening 134 is of quadrangular configuration; the polygonal rim 146 of the anode gas passage opening 134 may also have more or fewer than four corners.

The corners of the anode gas passage opening 134 are preferably of rounded configuration in order to prevent tearing of the bipolar plate layers 122 and 124 in the region of said corners.

In order to enable the exit of the anode gas from the interior space of the anode gas sealing bead 142, the anode gas sealing bead 142 is provided with a plurality of anode gas outlets 154 on its outer side facing away from the anode gas passage opening 134.

The anode gas outlets 154 are preferably arranged on a portion 156 of the anode gas sealing bead 142 that faces toward the electrochemically active region 114 of the bipolar plate 100.

The anode gas inlets 144 that are arranged on the same portion 156 of the anode gas sealing bead 142 are preferably offset relative to the anode gas outlets 154 along the peripheral direction of the anode gas sealing bead 142.

The anode gas flows through the anode gas outlets 154 on the portion 156 of the anode gas sealing bead 142 into an anode gas distribution region 170, which serves to distribute the anode gas as uniformly as possible to the anode gas flow channels 126 of the anode gas flow field 116.

The anode gas distribution region 170 comprises a plurality of respective directed distribution structures 172 and a plurality of respective undirected distribution structures 174, which serve to deflect the anode gas from its original flow direction.

The directed distribution structures 172 are hereby configured, e.g., as substantially linearly extending distribution webs 176.

The undirected distribution structures 174 are configured, e.g., as substantially bowl-shaped distribution nubs 178.

The distribution structures 172 and 174, like all other structures of the bipolar plate 100 described in the preceding and in the following, are preferably formed in one piece with the material of the bipolar plate layers 122 or 124 and are introduced into the respective bipolar plate layer 122 and 124 by a reshaping operation, for example by a stamping operation or a deep-drawing operation.

The cathode gas passage opening 136 is surrounded by a cathode gas sealing bead 162.

The coolant passage opening 138 is surrounded by a coolant sealing bead 164.

An annularly closed rim bead 182 extends around near the outer rim 180 of the bipolar plate 100.

The rim bead 182 encloses the electrochemically active region 114 of the bipolar plate 100, the anode gas passage openings 134, and the anode gas sealing beads 142 in both end regions 112, the cathode gas passage openings 136 and the cathode gas sealing beads 162 in both end regions 112, and the coolant passage openings 138 and the coolant sealing beads 164 in both end regions 112 of the bipolar plate 100.

The rim bead 182 serves to prevent leakage of the media to be supplied to the electrochemical device 106, in particular the anode gas, the cathode gas, and the coolant, from the electrochemical units 102 into the outside space 184 of the electrochemical device 106.

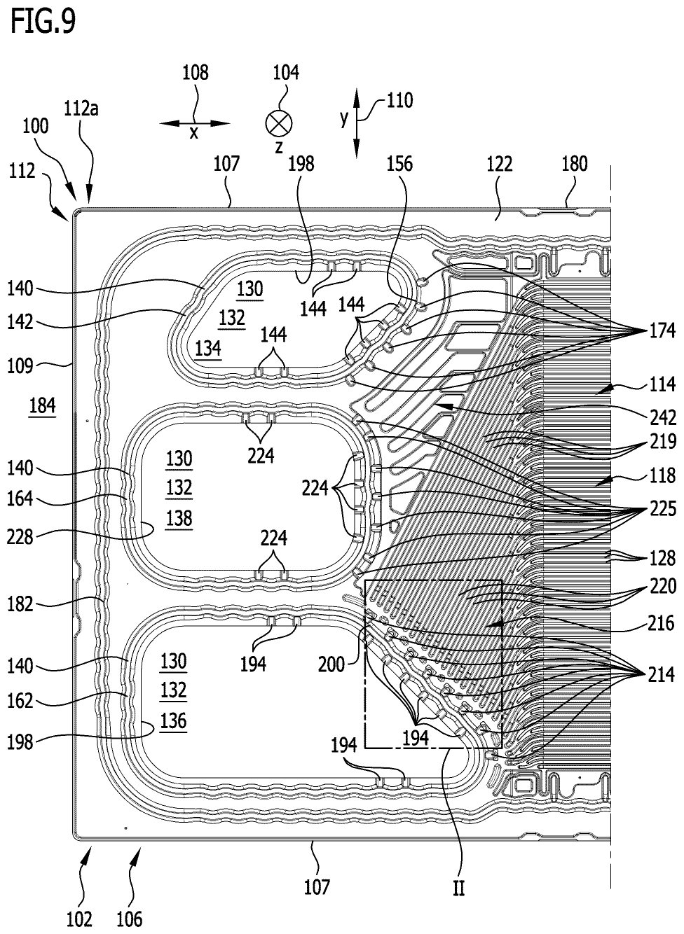

In order to allow the cathode gas to flow out of the cathode gas passage opening 136 through the cathode gas sealing bead 162, the cathode gas sealing bead 162 is provided with a plurality of cathode gas inlets 194 on its inner side facing toward the cathode gas passage opening 136 (see in particular FIG. 9).

Cathode gas travels from the cathode gas passage opening 136 through the cathode gas inlets 194 into the interior space of the cathode gas sealing bead 162.

The cathode gas inlets 194 preferably open on the rim 198 of the cathode gas passage opening 136.

In the graphically depicted embodiment, the rim 198 of the cathode gas passage opening 136 is of quadrangular configuration. The number of corners of the polygonal rim 198 may also be smaller or greater than four.

Cathode gas outlets 214 that are arranged on the outer side of the cathode gas sealing bead 162 facing away from the cathode gas passage opening 136 and through which the cathode gas flows out of the interior space of the cathode gas sealing bead 162 are preferably all arranged on a portion 200 of the cathode gas sealing bead 162 that faces toward the electrochemically active region 114 of the bipolar plate 100.

The cathode gas inlets 194 that are arranged on the same portion 200 of the cathode gas sealing bead 162 are preferably arranged offset relative to the cathode gas outlets 214 along the peripheral direction of the cathode gas sealing bead 162.

Preferably, a total of two or more cathode gas outlets 214, in particular four or more, particularly preferably six or more, namely eight in the embodiment depicted, are provided on the cathode gas sealing bead 162.

The cathode gas flows through the cathode gas outlets 214 into a cathode gas distribution region 216 of the bipolar plate 100, which serves to distribute the cathode gas as uniformly as possible to the cathode gas flow channels 128 of the cathode gas flow field 118.

For this purpose, the cathode gas distribution region comprises distribution structures 218, which are configured as directed distribution structures 220 or as undirected distribution structures 221.

The directed distribution structures 220 are preferably configured as linearly extending distribution webs 222.

The undirected distribution structures 221 are configured, e.g., as substantially bowl-shaped distribution nubs 223.

In order to allow the coolant to flow out of the coolant passage opening 138 into the coolant flow field 120 of the bipolar plate 100, the coolant sealing bead 164 is provided with a plurality of coolant inlets 224 on its inner side facing toward the coolant passage opening 138 (see in particular FIG. 2).

The coolant travels from the coolant passage opening 138 through the coolant inlets 224 into the interior space of the coolant sealing bead 164.

The rim 228 of the coolant passage opening 138 is of quadrangular configuration in the graphically depicted embodiment. The number of corners of the polygonal rim 228 of the coolant passage opening 138 may also be greater or smaller than four.

Coolant outlets 225 that are arranged on the outer side of the coolant sealing bead 164 facing away from the coolant passage opening 138 and through which the coolant flows out of the interior space of the coolant sealing bead 164 are preferably all arranged on a portion 230 of the coolant sealing bead 164 that faces toward the electrochemically active region 114 of the bipolar plate 114.

The coolant inlets 224 that are arranged on the same portion 230 of the coolant sealing bead 164 are preferably arranged offset relative to the coolant outlets 225 along the peripheral direction of the coolant sealing bead 164.

The coolant flows through the coolant outlets 225 into a coolant distribution region 242 of the bipolar plate 100, which serves to distribute the coolant as uniformly as possible to the coolant flow channels of the coolant flow field.

In this coolant distribution region 242, the anode-side bipolar plate layer 122 and the cathode-side bipolar plate layer 124 are arranged offset in opposite directions along the stack direction 104 relative to a longitudinal central plane of the bipolar plate 100 oriented perpendicularly to the stack direction 104, in such a way that a large cross-section that is able to be flowed through is available for the flow of the coolant through the coolant distribution region 242.

The bipolar plate 100 is preferably of rotationally symmetrical configuration with respect to a rotation by 180° about a rotational axis extending through the midpoint of the electrochemically active region 114 of the bipolar plate 100 and in parallel to the stack direction 104 (z-direction).

The medium passage openings 130 arranged in the second end region 112b, in particular the anode gas passage opening 134 arranged there, the cathode gas passage opening 136 arranged there, and the coolant passage opening 138 arranged there, are therefore preferably structured and arranged substantially identically to the anode gas passage opening 134, the cathode gas passage opening 136, and the coolant passage opening 138, respectively, in the first end region 112a, which have been described above.

The aim of the bipolar plate 100 depicted in FIGS. 1 to 14 and described above is to distribute the anode gas flowing out of the anode gas outlets 154 on the anode gas sealing bead 142 as uniformly as possible to the distribution channels 173 of the anode gas distribution region 170 formed between the directed distribution structures 172 and to distribute the cathode gas flowing out of the cathode gas outlets 214 on the cathode gas sealing bead 162 as uniformly as possible to the distribution channels 219 of the cathode gas distribution region 216 formed between the directed distribution structures 220.

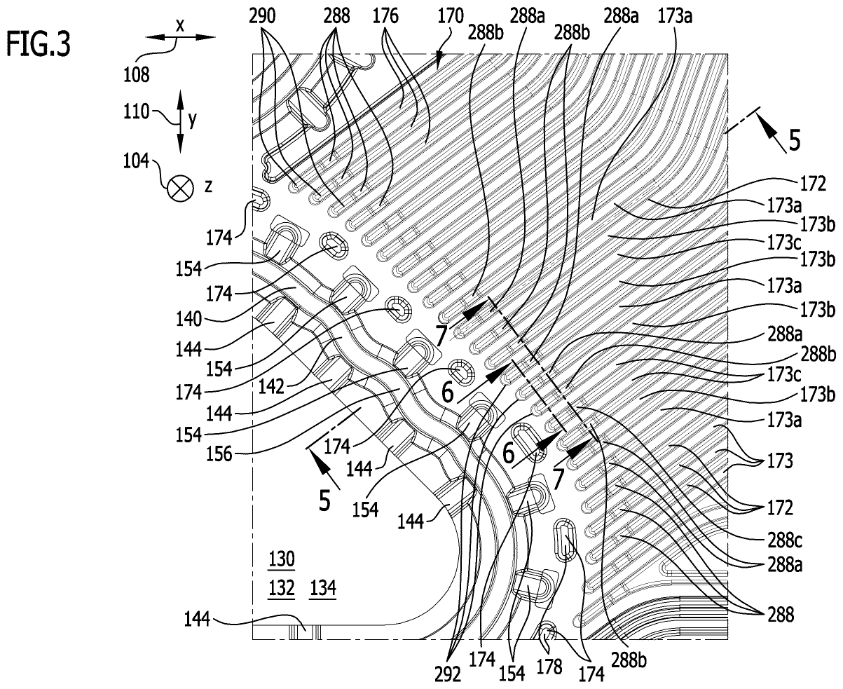

For this purpose, formed on the distribution structures 132 of the anode gas distribution region 170 are respective bypass channels 288, by way of each of which two adjacent distribution channels 173 of the anode gas distribution region 170 are in fluidic connection with one another (see in particular FIGS. 3, 4, and 7).

Likewise, formed on the distribution structures 220 of the cathode gas distribution region 216 is a respective bypass channel 288, by way of each of which two adjacent distribution channels 219 of the cathode gas distribution region 216 are in fluidic connection with one another.

Due to the bypass channels 288 in the anode gas distribution region 170, anode gas is able to flow from a distribution channel 173 into which a disproportionate amount of anode gas is flowing out of the anode gas outlets 154 into an adjacent distribution channel 173 that contains less anode gas from the anode gas outlets 154.

Likewise, due to the bypass channels 288 in the cathode gas distribution region 216, cathode gas is able to flow from a distribution channel 219 that contains a disproportionate amount of cathode gas from the cathode gas outlets 214 into an adjacent distribution channel 219 that contains less cathode gas from the cathode gas outlets 214.

In this way, the filling of the distribution channels 173, 219 with anode gas and cathode gas respectively is made more uniform.

As a result of this, the anode gas flow channels 126 of the anode gas flow field 116 that are supplied with anode gas from the anode gas distribution region 170 and the cathode gas flow channels 128 of the cathode gas flow field 118 that are supplied with cathode gas from the cathode gas distribution region 216 are filled more uniformly with anode gas and with cathode gas respectively.

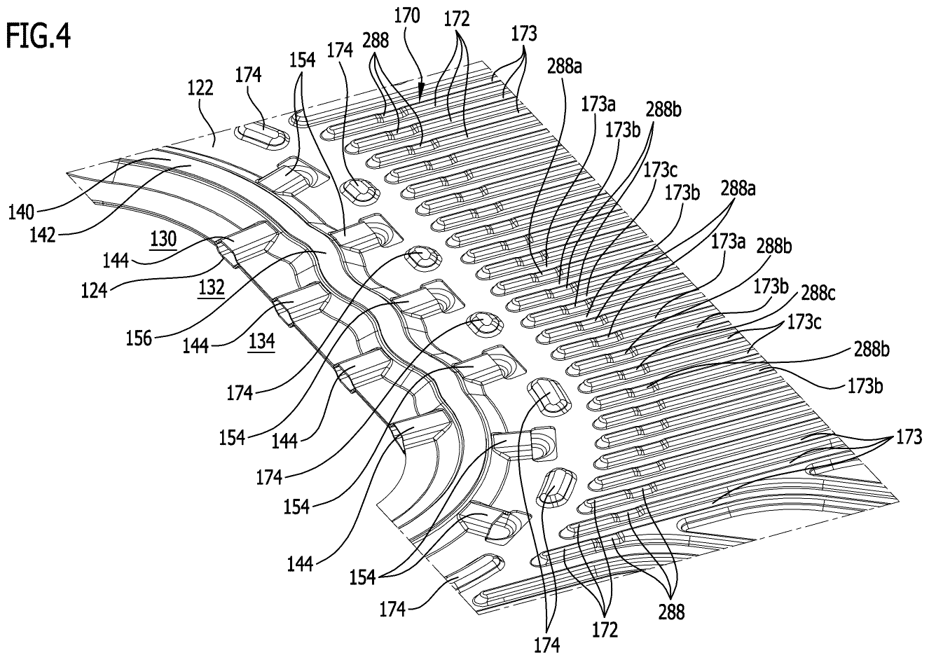

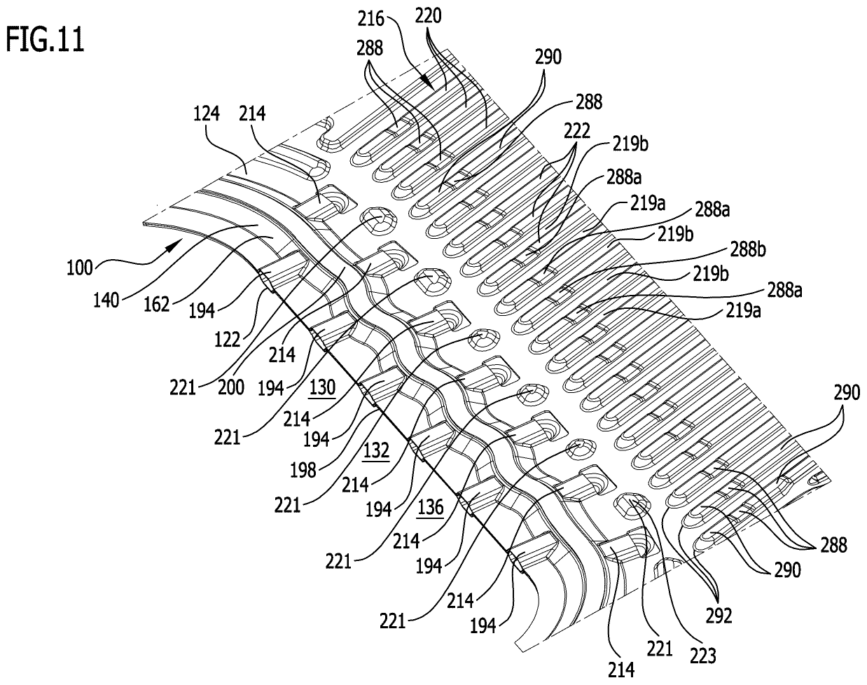

As can best be seen in the perspective depictions of FIGS. 4 and 11, the bypass channels 288 are formed by a local depression of the respective distribution structure 172 and 220 on which the respective bypass channel 288 is formed.

Here, the local depression of the distribution structure 172, 220 preferably corresponds to at least 5%, in particular at least 10%, particularly preferably at least 20%, of the height of the locally depressed distribution structure 172, 220 in a non-depressed portion 290 of the respective distribution structure 172, 220 adjacent to the respective bypass channel 288.

Further, provision is preferably made that the local depression of the distribution structure 172, 220 on which the respective bypass channel 288 is formed corresponds to at most 95%, in particular at most 90%, particularly preferably at most 80%, for example at most 50%, of the height of the locally depressed distribution structure 172, 220 in a non-depressed portion 290 of the respective distribution structure 172, 220.

Provision is preferably made that the local depression is at least 20 μm, in particular at least 40 μm, particularly preferably at least 80 μm.

Furthermore, provision is preferably made that the local depression is at most 380 μm, in particular at most 360 μm, particularly preferably at most 320 μm, for example at most 200 μm.

The extent of the local depression and thus of the bypass channel 288 in the longitudinal direction of the respective locally depressed distribution structure 172, 220 is preferably at most 1.5 mm. This prevents a component of an electrochemical unit 102 supported by the respective distribution structure 172, 220, for example a gas diffusion layer or a part of a seal arrangement of an electrochemical unit 102, from not being sufficiently supported by the respective distribution structure 172, 220 and thereby bulging into the respective bypass channel 288, which would undesirably reduce the cross-section of the respective bypass channel 288 that is able to be flowed through.

Associated with each anode gas outlet 154 on the anode gas sealing bead 142 is a respective first-order distribution channel 173a of the anode gas distribution region 170, which is arranged and oriented relative to the anode gas outlet 154 such that the largest proportion of the anode gas flowing out of the anode gas outlet 154 flows into this first-order distribution channel 173a.

Adjacent to each first-order distribution channel 173a of the anode gas distribution region 170 are two respective second-order distribution channels 173b, and adjacent to each of the second-order distribution channels 173b is a respective third-order distribution channel 173c, wherein each second-order distribution channel 173b contains less anode gas from the anode gas outlets 154 than a first-order distribution channel 173a, and wherein each third-order distribution channel 173c contains less anode gas from the anode gas outlets 154 than a second-order distribution channel 173b.

Each first-order distribution channel 173a is in fluidic connection with one of the adjacent second-order distribution channels 173b by way of a respective first-order bypass channel 288a.

Each of the second-order distribution channels 173b is in fluidic connection with an adjacent third-order distribution channel 173c by way of a respective second-order bypass channel 288b.

Third-order distribution channels 173c may be in fluidic connection with an adjacent further third-order distribution channel 173c by way of a respective third-order bypass channel 288c.

In order to distribute the anode gas as uniformly as possible to the different orders of distribution channels 173a, 173b and 173c, more anode gas must flow through the first-order bypass channels 288a than through the second-order bypass channels 288b.

The first-order bypass channels 288a therefore each have a larger cross-section that is able to be flowed through than the second-order bypass channels 288b.

The second-order bypass channels 288b preferably have a larger cross-section that is able to be flowed through than the third-order bypass channels 288c.

As can best be seen in FIG. 3, the second-order bypass channels 288b overlap at least partially with the respective adjacent first-order bypass channels 288a, when viewed in a direction oriented perpendicularly to the longitudinal direction of the first-order distribution channel 173a and perpendicularly to the stack direction 104.

This ensures that the anode gas that has flowed through a first-order bypass channel 288a is also able to flow through the second-order bypass channel 288b without changing flow direction or with only a small change to the flow direction.

For the same reason, it is favorable that the bypass channels 288 overlap at least partially with at least one bypass channel 288 formed in an adjacent distribution structure 172, when viewed in a direction oriented perpendicularly to the longitudinal direction of the distribution structure 172 in which the bypass channels 288 are each formed and perpendicularly to the stack direction 104.

The distances of the bypass channels 288 from an end 292 of the respective distribution structure 172 facing away from the electrochemically active region 114 of the bipolar plate 100, on which distribution structure the respective bypass channel 288 is formed, along the longitudinal direction of said distribution structure 172 is greater than the extent of the respective bypass channel 288 along the longitudinal direction of the distribution structure 172.

Associated with each cathode gas outlet 214 on the cathode gas sealing bead 162 is a respective first-order distribution channel 219a of the cathode gas distribution region 216, which is arranged and oriented relative to the cathode gas outlet 214 such that the largest proportion of the cathode gas flowing out of the cathode gas outlet 214 flows into this first-order distribution channel 219a.

Adjacent to each first-order distribution channel 219a of the cathode gas distribution region 216 are two respective second-order distribution channels 219b, and a respective further second-order distribution channel 219b may be associated with each of the second-order distribution channels 219b, wherein each second-order distribution channel 219b contains less cathode gas from the cathode gas outlets 214 than a first-order distribution channel 219a.

Each first-order distribution channel 219a is in fluidic connection with one of the adjacent second-order distribution channels 219b by way of a respective first-order bypass channel 288a.

Second-order distribution channels 219b may be in fluidic connection with an adjacent further second-order distribution channel 219b by way of a respective second-order bypass channel 288b.

In order to distribute the cathode gas as uniformly as possible to the different orders of distribution channels 219a and 219b, more cathode gas must flow through the first-order bypass channels 288a than through the second-order bypass channels 288b.

The first-order bypass channels 288a therefore each have a larger cross-section that is able to be flowed through than the second-order bypass channels 288b.

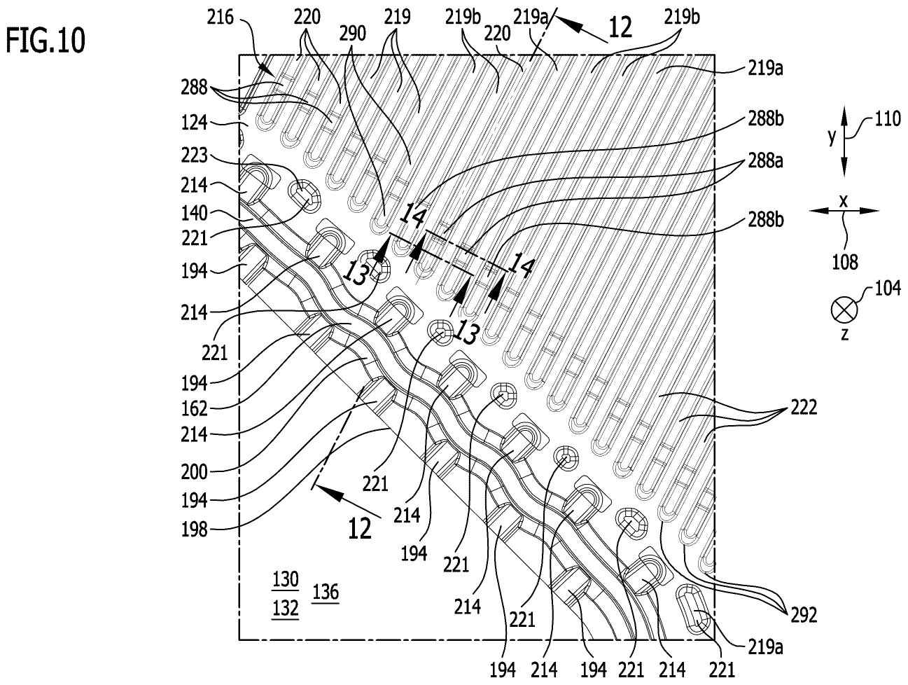

As can best be seen in FIG. 10, the second-order bypass channels 288b overlap at least partially with the respective adjacent first-order bypass channels 288a, seen in a direction oriented perpendicularly to the longitudinal direction of the first-order distribution channel 219a and perpendicularly to the stack direction 104.

This ensures that the cathode gas that has flowed through a first-order bypass channel 288a is able to also flow through the second-order bypass channel 288b without changing flow direction or with only a small change to the flow direction.

For the same reason, it is favorable that the bypass channels 288 overlap at least partially with at least one bypass channel 288 formed in an adjacent distribution structure 220, when viewed in a direction oriented perpendicularly to the longitudinal direction of the distribution structure 220 in which the bypass channels 288 are each formed and perpendicularly to the stack direction 104.

The distances of the bypass channels 288 from an end 292 of the respective distribution structure 220 facing away from the electrochemically active region 114 of the bipolar plate 100, on which distribution structure 220 the respective bypass channel 288 is formed, along the longitudinal direction of said distribution structure 220 is greater than the extent of the respective bypass channel 288 along the longitudinal direction of the distribution structure 220.

1. A bipolar plate for an electrochemical unit of an electrochemical device comprising a plurality of electrochemical units that follow one another along a stack direction, wherein the bipolar plate comprises the following:
an anode gas passage opening, which forms a constituent part of an anode gas channel that extends along the stack direction through the electrochemical device;
a cathode gas passage opening, which forms a constituent part of a cathode gas channel that extends along the stack direction through the electrochemical device;
an electrochemically active region of the bipolar plate, which comprises an anode gas flow field that is able to be flowed through by the anode gas and a cathode gas flow field that is able to be flowed through by the cathode gas;
an anode gas distribution region, by way of which the anode gas passage opening is in fluidic connection with the anode gas flow field; and
a cathode gas distribution region, by way of which the cathode gas passage opening is in fluidic connection with the cathode gas flow field;
wherein at least one of i) the anode gas distribution region and ii) the cathode gas distribution region comprises distribution structures extending along a flow direction of the anode gas and the cathode gas respectively, which delimit distribution channels formed between two respective distribution structures,
wherein at least one of i) the anode gas distribution region and ii) the cathode gas distribution region each has at least one bypass channel, by way of which two mutually adjacent distribution channels are in fluidic connection with one another.

2. The bipolar plate in accordance with claim 1, wherein the at least one bypass channel is formed by a local depression of one of the distribution structures.

3. The bipolar plate in accordance with claim 2, wherein the local depression corresponds to at least 5% of the height of the locally depressed distribution structure in a non-depressed portion of the distribution structure.

4. The bipolar plate in accordance with claim 2, wherein the local depression corresponds to at most 95% of the height of the locally depressed distribution structure in a non-depressed portion of the distribution structure.

5. The bipolar plate in accordance with claim 2, wherein the local depression is at least 20 μm.

6. The bipolar plate in accordance with claim 2, wherein the local depression is at most 380 μm.

7. The bipolar plate in accordance with claim 2, wherein the extent of the local depression in the longitudinal direction of the locally depressed distribution structure is at most 1.5 mm.

8. The bipolar plate in accordance with claim 2, wherein the anode gas passage opening is surrounded by an anode gas sealing bead, on the outer side of which facing away from the anode gas passage opening an anode gas outlet is arranged, and the cathode gas passage opening is surrounded by a cathode gas sealing bead, on the outer side of which facing away from the cathode gas passage opening a cathode gas outlet is arranged,
wherein at least one of the following applies:
a) the largest proportion of the anode gas flowing out of the anode gas outlet flows into a first-order distribution channel of the anode gas distribution region; and
b) the largest proportion of the cathode gas flowing out of the cathode gas outlet flows into a first-order distribution channel of the cathode gas distribution region,
wherein adjacent to the respective first-order distribution channel are two second-order distribution channels and adjacent to the respective second-order distribution channels is a respective third-order distribution channel or a further second-order distribution channel,
wherein the respective first-order distribution channel is in fluidic connection with the second-order distribution channels by way of a respective first-order bypass channel and the second-order distribution channels are each in fluidic connection with one of the third-order distribution channels or with a further second-order distribution channel by way of a respective second-order bypass channel, and
wherein the first-order bypass channels each have a larger cross-section that is able to be flowed through than the second-order bypass channels.

9. The bipolar plate in accordance with claim 8, wherein the second-order bypass channels overlap at least partially with the respective adjacent first-order bypass channels, seen in a direction oriented perpendicularly to the longitudinal direction of the first-order distribution channel and perpendicularly to the stack direction.

10. The bipolar plate in accordance with claim 1, wherein at least one bypass channel overlaps at least partially with at least one bypass channel formed in an adjacent distribution structure, when viewed in a direction oriented perpendicularly to the longitudinal direction of the distribution structure on which the respective bypass channel is formed and perpendicularly to the stack direction.

11. The bipolar plate in accordance with claim 1, wherein at least one of i) more than half of the directed distribution structures of the anode gas distribution region and ii) more than half of the directed distribution structures of the cathode gas distribution region are each provided with at least one respective bypass channel.

12. The bipolar plate in accordance with claim 1, wherein at least one of i) all directed distribution structures of the anode gas distribution region and ii) all directed distribution structures of the cathode gas distribution region are each provided with at least one respective bypass channel.

13. The bipolar plate in accordance with claim 1, wherein at least one of i) at least one distribution structure of the anode gas distribution region and ii) at least one distribution structure of the cathode gas distribution region is provided with two or more bypass channels spaced at a distance from one another in the longitudinal direction of the respective distribution structure.

14. The bipolar plate in accordance with claim 1, wherein at least one of i) at least one distribution structure of the anode gas distribution region and ii) at least one distribution structure of the cathode gas distribution region is provided with a bypass channel, the distance of which from an end of the respective distribution structure pointing away from the electrochemically active region of the bipolar plate along the longitudinal direction of the distribution structure is greater than the extent of the bypass channel along the longitudinal direction of the distribution structure.

15. An electrochemical device, comprising a plurality of electrochemical units that follow one another along a stack direction and each comprise a bipolar plate for an electrochemical unit of the electrochemical device, wherein the bipolar plate comprises the following:
an anode gas passage opening, which forms a constituent part of an anode gas channel that extends along the stack direction through the electrochemical device;
a cathode gas passage opening, which forms a constituent part of a cathode gas channel that extends along the stack direction through the electrochemical device;
an electrochemically active region of the bipolar plate, which comprises an anode gas flow field that is able to be flowed through by the anode gas and a cathode gas flow field that is able to be flowed through by the cathode gas;
an anode gas distribution region, by way of which the anode gas passage opening is in fluidic connection with the anode gas flow field; and
a cathode gas distribution region, by way of which the cathode gas passage opening is in fluidic connection with the cathode gas flow field;
wherein at least one of i) the anode gas distribution region and ii) the cathode gas distribution region comprises distribution structures extending along a flow direction of the anode gas and the cathode gas respectively, which delimit distribution channels formed between two respective distribution structures,
wherein at least one of i) the anode gas distribution region and ii) the cathode gas distribution region each has at least one bypass channel, by way of which two mutually adjacent distribution channels are in fluidic connection with one another.
